(19) United States
(12) Patent Application Publication
(10) Pub. No.: US 2024/0239335 A1
(43) Pub. Date: Jul. 18, 2024

(54) VEHICLE CONTROL APPARATUS, VEHICLE CONTROL METHOD, AND PROGRAM THEREOF

(71) Applicant: TOYOTA JIDOSHA KABUSHIKI KAISHA, Toyota-shi (JP)

(72) Inventor: Kazuya OKAMOTO, Toyota-shi (JP)

(73) Assignee: TOYOTA JIDOSHA KABUSHIKI KAISHA, Toyota-shi (JP)

(21) Appl. No.: 18/539,924

(22) Filed: Dec. 14, 2023

(30) Foreign Application Priority Data
Jan. 17, 2023 (JP) 2023-004839

(51) Int. Cl. B60W 30/09; B60W 30/095; B60W 30/14; B60W 40/105; B60W 50/14; H04W 4/46

(52) U.S. Cl. CPC B60W 30/09; B60W 30/0956; B60W 30/146; B60W 40/105; B60W 50/14; H04W 4/46; B60W 2050/146; B60W 2520/10; B60W 2554/4041; B60W 2554/80; B60W 2556/65

(57) ABSTRACT

A vehicle control apparatus comprises, a sensor, mounted on a host vehicle, configured to detect an object outside of the host vehicle, and obtain host-vehicle-object-information on the detected object; a receiving device configured to receive external object information on an object detected by an external device outside of the host vehicle from the external device; and a control unit capable of performing a predetermined control based on at least the host-vehicle-object-information. The control unit is configured to perform the control based on the host-vehicle-object-information when a blocking condition is not satisfied, the blocking condition being a condition to be satisfied when a sensor object that is an object detected by the sensor is present at a position where the sensor object blocks a full scan of the sensor; and to perform the control based on the host-vehicle-object-information and the external object information when the blocking condition is satisfied.

### TECHNICAL FIELD

The present disclosure relates to a vehicle control apparatus configured to perform a predetermined control based on host-vehicle-object-information obtained by a sensor mounted on a host vehicle, a vehicle control method implemented by a computer mounted on the host vehicle for performing the control based on the host-vehicle-object-information, and a program causing the computer to perform the control based on the host-vehicle-object-information.

### BACKGROUND

There has been a known vehicle control apparatus configured to perform a predetermined control based on host-vehicle-object-information that is information on an object around (in the vicinity of) a host vehicle. The host-vehicle-object-information is information that is obtained by a sensor (e.g., a camera, a millimeter wave radar, or the like) mounted on the host vehicle.

For example, a vehicle control apparatus (hereinafter, referred to as a “conventional apparatus”) disclosed in Japanese Patent Application Laid-Open No. 2008-15920 determines whether or not the host vehicle has a possibility of colliding with a preceding vehicle based on the host-vehicle-object-information and other-vehicle-object-information, when the host vehicle cannot carry out a vehicle-to-vehicle communication with the preceding vehicle. The other-vehicle-object-information is information that is obtained through the vehicle-to-vehicle communication with other vehicles traveling in the vicinity of the host vehicle. The conventional apparatus performs a predetermined control (e.g., an alert control) when it is determined that the host vehicle has a possibility of colliding with the preceding vehicle.

When the conventional apparatus determines that the host vehicle can carry out the vehicle-to-vehicle communication with the preceding vehicle, the conventional apparatus does not make the determination as to whether or not the host vehicle has a possibility of colliding with the preceding vehicle. This is because the preceding vehicle can travel safely based on the other-vehicle-object-information.

### SUMMARY

Even when the host vehicle can carry out the vehicle-to-vehicle communication with the preceding vehicle, it is preferable that the determination as to whether or not the host vehicle has a possibility of colliding with the preceding vehicle be always made, and the predetermined control be performed when it is determined that the host vehicle has the possibility of colliding with the preceding vehicle. Meanwhile, a sensor cannot fully scan its detection area when an object is present at a position such that (where) the object blocks the detection area. In such a case, it is preferable that object information on an object that is located in the area that the sensor cannot scan be obtained from an external device (e.g., other vehicle) and the determination as to whether or not the host vehicle has a possibility of colliding with the object be made based on the object information obtained from the external device.

Whereas, when an object that blocks the detection area is not present, the sensor can fully scan its detection area. In such a case, if the object information is obtained from the external device, information processing load for processing the object information is wasted.

The present disclosure is made to cope with the problem described above. That is, one of objectives of the present disclosure is to provide a vehicle control apparatus that can decrease the information processing load and that still be able to perform the above-described control appropriately.

A vehicle control apparatus (hereinafter, referred to as a “present disclosure apparatus”) according to the present disclosure comprises:
a sensor (22, 24, 26L, 26R), mounted on a host vehicle, configured to detect an object that is present outside of the host vehicle, and obtain host-vehicle-object-information on the detected object;
a receiving device (36) configured to receive external object information on an object detected by an external device that is located outside of the host vehicle from the external device; and
a control unit (20) capable of performing a predetermined control based on at least the host-vehicle-object-information.

The control unit is configured to:
perform the control based on the host-vehicle-object-information (step 455, step 435 to step 450) when a blocking condition is not satisfied, the blocking condition being a condition to be satisfied when a sensor object that is an object detected by the sensor is present at a position with respect to the host vehicle where the sensor object blocks a full scan of the sensor (step 415: No); and
perform the control based on the host-vehicle-object-information and the external object information (step 430 to step 450) when the blocking condition is satisfied (step 415: Yes).

When the blocking condition is not satisfied, it is likely that the sensor mounted on the host vehicle can fully scan its detection area. Thus, when the blocking condition is not satisfied, the present disclosure apparatus performs the above-described control based on the host-vehicle-object-information without using the external object information. Therefore, in this case, the present disclosure apparatus can decrease the processing load for the external object information.

Whereas, when the blocking condition is satisfied, it is likely that the sensor cannot fully scan the detection area, because the detection area is blocked by the sensor object. The external device has a possibility of detecting an object that is present in an “area of the detection area of the sensor” that is blocked by the sensor object. Thus, the present disclosure apparatus performs the above-described control based on the host-vehicle-object-information and the external object information. Therefore, since the present disclosure apparatus can increase a possibility to recognize the object that is present in the “area of the detection area of the sensor” that is blocked by the sensor object when the blocking condition is satisfied. This enables the present disclosure apparatus to perform the above-described control appropriately, even when the blocking condition is satisfied.

In one of embodiments of the present disclosure apparatus, the control unit is configured to determine that the blocking condition is satisfied (step 520), when at least one of a first condition (step 515) and a second condition is satisfied.

The first condition is a condition to be satisfied when a distance between the host vehicle and the sensor object is equal to or shorter than a predetermined distance.

The second condition is a condition to be satisfied when the sensor object is located in a blocking area that has been set outside of the host vehicle.

When at least one of the first condition and the second condition is satisfied, it is likely that the sensor object blocks the detection area of the sensor. The present disclosure apparatus can increase a possibility that the blocking condition is determined to be satisfied, when the sensor object blocks the detection area of the sensor.

In the above-described embodiment,
the control unit is configured to determine that the blocking condition is satisfied (step 520), when at least one of the first condition and the second condition is satisfied and when both of a third condition (step 505) and a fourth condition are satisfied (step 510).

The third condition is a condition to be satisfied when a vehicle speed of the host vehicle is equal to or lower than a first speed threshold (step 505).

The fourth condition is a condition to be satisfied when a magnitude of a relative speed of the sensor object with respect to the host vehicle is equal to or lower than a second speed threshold (step 510).

When both of the third condition (step 505) and the fourth condition are satisfied, it is likely that the sensor object continues blocking the detection area of the sensor. The above-described embodiment can increase a possibility that the blocking condition is determined to be satisfied, when the sensor object continues blocking the detection area of the sensor.

In one of embodiments of the present disclosure apparatus,
the control unit is configured to:
   when the blocking condition is not satisfied (step 415: No), perform the control based on a collision possibility of a collision between the host vehicle and an object recognized based on the host-vehicle-object-information (step 455, step 435 to step 450); and
   when the blocking condition is satisfied (step 415: Yes), perform the control based on a collision possibility of a collision between the host vehicle and an object recognized based on the host-vehicle-object-information and the external object information (step 430 to step 450).

In one of embodiments of the present disclosure apparatus,
the sensor (26L, 26R) is configured to detect an object that is present in a side area of the host vehicle as the sensor object, and to obtain the host-vehicle-object-information on the sensor object.

The control unit is configured to:
in a case where the blocking condition is not satisfied (step 415: No), perform, as the control, at least one of an alert control to notify a driver of presence of the object (step 440) and a deceleration control to decelerate the host vehicle (step 450), when it is determined that the object recognized based on the host-vehicle-object-information is present in a predetermined side collision area that has been set in a side area of the host vehicle and is coming close to the host vehicle (step 455, step 435: Yes); and
in a case where the blocking condition is satisfied (step 415: Yes), perform, as the control, at least one of the alert control (step 440) and the deceleration control (step 450), when it is determined that the object recognized based on the host-vehicle-object-information and the external object information is present in the side collision area and is coming close to the host vehicle (step 430, step 435: Yes).

The collision possibility of an object that satisfies a condition that the object is in the side collision area and is coming close to the host vehicle is higher than the collision possibility of an object that does not satisfy this condition. When such a condition is satisfied, at least one of the alert control and the deceleration control is performed as the above-described control. According to the above embodiment, when the object satisfies the condition is determined to be present, at least one of the alert control and the deceleration control is performed as the above-described control. Thus, a possibility of avoiding the collision between the host vehicle and the object or of mitigating the damage caused by the collision can be increased.

In one of embodiments of the present disclosure apparatus,
the control unit is configured to, when a kind of the sensor object that is present at the position where the sensor object blocks the full scan of the sensor is a vehicle (step 605: Yes), obtain the external object information by carrying out a vehicle-to-vehicle communication with this vehicle (step 615).

When a kind of the sensor object that is present at the position where the sensor object blocks the full scan of the sensor is a vehicle, it is likely that the sensor mounted on this vehicle (that is the sensor object) can scan adequately an “area within the detection area of the sensor mounted on the host vehicle” that this vehicle blocks. According to the embodiment, the external object information is obtained from this vehicle (the sensor object) through the vehicle-to-vehicle communication with this vehicle. Therefore, a possibility that the object that is present in the area that is blocked by the sensor object (vehicle) is recognized can be increased.

In one of embodiments of the present disclosure apparatus,
the control unit is configured to notify a driver that the blocking condition is satisfied (step 460), when the blocking condition is satisfied.

This causes the driver to notify that the blocking condition is satisfied, and thus, to drive more carefully when the blocking condition is satisfied.

A vehicle control method according to the present disclosure is a method that is executed/performed by a computer installed on a host vehicle to perform a predetermined control based on host-vehicle-object-information on a sensor object that is an object outside of the host vehicle which a sensor mounted on the host vehicle detects.

The vehicle control method comprises:
a first step (step 455, step 435 to step 450) of performing the control based on the host-vehicle-object-information when a blocking condition is not satisfied (step 415: No), the blocking condition being a condition to be satisfied when the sensor object is present at a position where the sensor object blocks a full scan of the sensor; and
a second step (step 430 to step 450) of obtaining external object information on an object detected by an external device outside of the host vehicle from the external device, and of performing the control based on the host-vehicle-object-information and the external object information, when the blocking condition is satisfied (step 415: Yes).

A program storage device, readable by machine, storing a program according to the present disclosure that is a program for causing a computer (20) installed on a host vehicle to perform a predetermined control based on host-vehicle-object-information on a sensor object which a sensor (22, 24, 26L, 26R) mounted on the host vehicle detects.

The program causes the computer to implement processes of:
performing the control based on the host-vehicle-object-information (step 455, step 435 to step 450) when a blocking condition is not satisfied (step 415: No), the blocking condition being a condition to be satisfied when the sensor object is present at a position where the sensor object blocks a full scan of the sensor; and
obtaining external object information on an object detected by an external device outside of the host vehicle from the external device, and performing the control based on the host-vehicle-object-information and the external object information (step 430 to step 450), when the blocking condition is satisfied (step 415: Yes).

According to the above-described vehicle control method and program, the information processing load of the computer installed on the host vehicle can be decreased while the above-described control can be appropriately performed.

### BRIEF DESCRIPTION OF THE DRAWINGS

FIG. 1 is a schematic system diagram of a vehicle control apparatus according to an embodiment of the present disclosure.

FIG. 2 is a drawing for describing detection areas of millimeter wave radars that the vehicle control apparatus comprises.

FIG. 3 is a drawing for describing an example of operation of the vehicle control apparatus.

FIG. 4 is a flowchart illustrating a routine executed by a CPU of a vehicle control ECU shown in FIG. 1.

FIG. 5 is a flowchart illustrating a sub routine executed by the CPU of the vehicle control ECU shown in FIG. 1.

FIG. 6 is a flowchart illustrating a sub routine executed by the CPU of the vehicle control ECU shown in FIG. 1.

FIG. 7 is a drawing for describing an example of operation of a vehicle control apparatus of a sixth modification of the embodiment according to the present disclosure.

### DETAILED DESCRIPTION

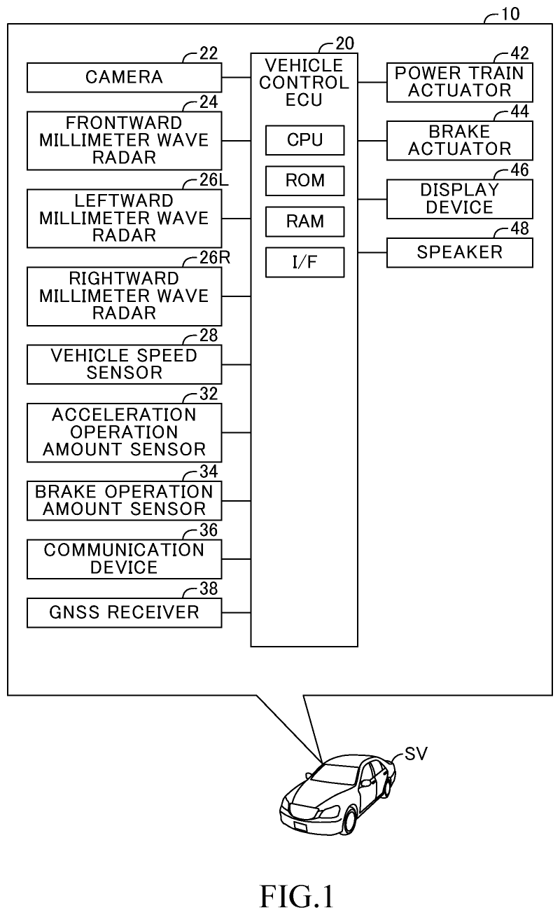

As shown in FIG. 1, a vehicle control apparatus (hereinafter, referred to as a “present apparatus”) 10 according to an embodiment of the present disclosure is applied to a host host vehicle SV. The present apparatus 10 comprises component elements shown in FIG. 1.

A vehicle control ECU 20 is an ECU that performs a predetermined control based on at least host-vehicle-object-information, and hereinafter, is expressed as the “ECU 20”.

In the present specification, an “ECU” is an electronic control unit/device including a microcomputer as a main component. The ECU may also be referred to as a “control unit”, a “controller”, or a “computer”. The microcomputer includes a CPU (processor), a ROM, a RAM, and an interface (I/F). At least one of functions that the ECU 20 realizes/implements may be realized/implemented by a plurality of ECUs.

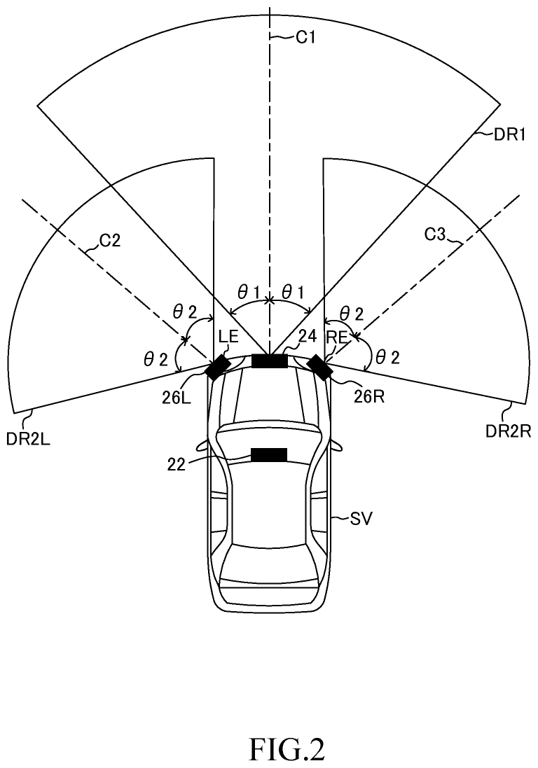

As shown in FIG. 2, a camera 22 is arranged/disposed at an upper position of a front windshield of the host vehicle SV. The camera 22 obtains image data by taking a picture of a scene in front (ahead) of the host vehicle SV. The camera 22 obtains camera object information based on the image data, and transmits the camera object information to the ECU 20. The camera object information includes a position of an object that is present/located in front of the host vehicle SV with respect to the host vehicle SV.

When a frontward millimeter wave radar 24, a leftward millimeter wave radar 26L, and a rightward millimeter wave radar 26R need not be differentiated from each other, each of the radars is referred to as a “millimeter wave radar”. When the leftward millimeter wave radar 26L and the rightward millimeter wave radar 26R need not be differentiated from each other, each of the radars is referred to as a “sideward millimeter wave radar 26”.

A millimeter wave radar radiates a millimeter wave. The radiated millimeter wave is reflected by an object so as to change into a reflection wave. The millimeter wave radar detects the object by radiating (transmitting) the millimeter wave and receiving the reflection wave. The millimeter wave radar obtains/specifies a position of the object with respect to the host vehicle SV, and a relative speed of the object with respect to the host vehicle SV. The millimeter wave radar transmits radar object information including “the specified position and the specified relative speed” of the object to the ECU 20.

As shown in FIG. 2, the frontward millimeter wave radar 24 is arranged at a center position in a vehicle width direction of a front end of the host vehicle SV. The frontward millimeter wave radar 24 detects an object that is present/located in a detection area DR1 in front of the host vehicle SV. The detection area DR1 is a sectoral area that has a center axis C1, and has an angle θ1 from the center axis C1 leftward and the angle θ1 from the center axis C1 rightward. The center axis C1 extends frontward from the disposed position of the frontward millimeter wave radar 24 along/in a front-rear axis direction of the host vehicle SV.

As shown in FIG. 2, the leftward millimeter wave radar 26L is arranged/disposed at a left end position in the vehicle width direction of the front end of the host vehicle SV. The leftward millimeter wave radar 26L detects an object that is present/located in a detection area DR2L that is located at a front left side of the host vehicle SV. The detection area DR2L is a sectoral area that has a center axis C2, and has an angle θ2 from the center axis C2 leftward and the angle θ2 from the center axis C2 rightward. The center axis C2 extends from the disposed position of the leftward millimeter wave radar 26L obliquely/diagonally forward left of the host vehicle SV.

As shown in FIG. 2, the rightward millimeter wave radar 26R is arranged/disposed at a right end position RE in the vehicle width direction of the front end of the host vehicle SV. The rightward millimeter wave radar 26R detects an object that is present/located in a detection area DR2R that is located at a front right side of the host vehicle SV. The detection area DR2R is a sectoral area that has a center axis C3, and has the angle θ2 from the center axis C3 leftward and the angle θ2 from the center axis C3 rightward. The center axis C3 extends from the disposed position of the rightward millimeter wave radar 26R obliquely/diagonally forward right of the host vehicle SV.

It should be noted that, when the detection area DR2R and the detection area DR2R need not be differentiated from each other, each of them is referred to as a “sideward detection area”. An object that is detected by either the leftward millimeter wave radar 26L or the rightward millimeter wave radar 26R may sometimes be referred to as a “sideward object”. The angle θ2 of the detection area DR2L of the leftward millimeter wave radar 26L may be equal to or different from the angle θ2 of the detection area DR2R of the rightward millimeter wave radar 26R.

The camera 22 and the millimeter wave radar are sensors for detecting an object, and each of them may simply be referred to as a “sensor”. An object detected by the camera 22 or the millimeter wave radar may sometimes be referred to as a sensor object.

A vehicle speed sensor 28 detects/measures a vehicle speed Vs indicative of a speed of the host vehicle SV. An acceleration pedal operation amount sensor 32 detects an operation amount AP (hereinafter, referred to as an “acceleration operation amount AP”) of an unillustrated acceleration pedal of the host vehicle SV. A brake pedal operation amount sensor 34 detects an operation amount BP (hereinafter, referred to as a “brake operation amount BP”) of an unillustrated brake pedal of the host vehicle SV. The ECU 20 obtains detection values of the sensors 28 to 34. A communication device 36 communicates with an external device (e.g., other vehicle) located outside of the host vehicle SV. The communication device 36 may sometimes be called a receiving device. A GNSS (Global Navigation Satellite System) receiver 28 receives signals from a plurality of artificial satellites, and specifies a present/current position of the host vehicle SV based on the received signals.

A power train actuator 42 changes a torque generated by a driving apparatus (e.g., an internal combustion engine and/or an electric motor) of the host vehicle SV. A brake actuator 44 controls a brake force applied to wheels of the host vehicle SV. A display device 46 displays an alert screen described later. A speaker 48 generates an alert sound described later.

### Predetermined Control

In the present embodiment, the ECU 20 specifies a position of an object (sensor object) based on the camera object information and the radar object information. When there is an object that is coming close to (or approaching) the host vehicle SV from the frontward side area of the host vehicle SV, the ECU 20 performs a predetermined control. It should be noted that, since the camera object information and the radar object information are information that the sensor mounted on the host vehicle SV obtains, they are referred as “host-vehicle-object-information”.

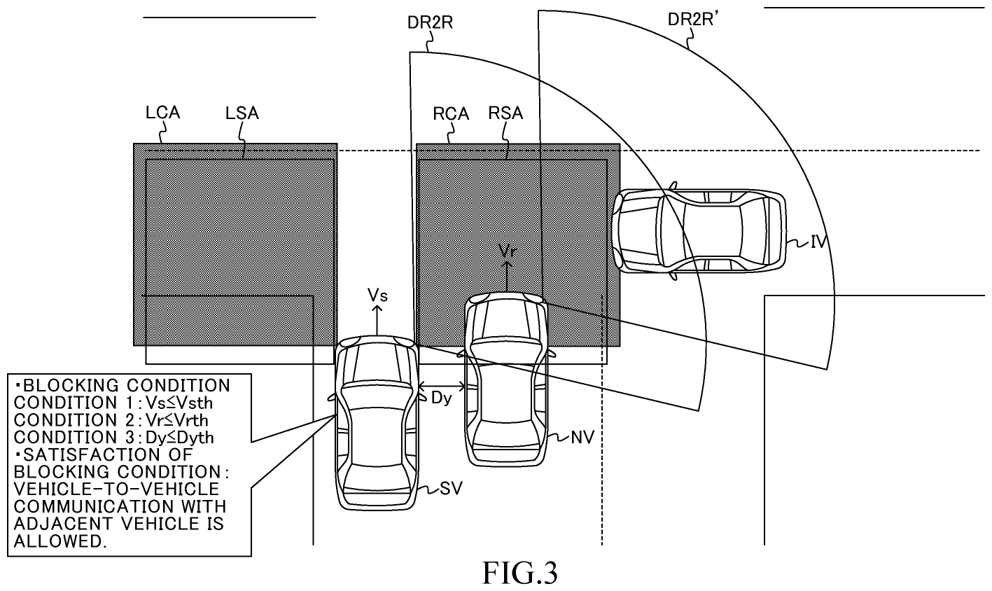

More specifically, as shown in FIG. 3, the ECU 20 has set a left side collision area LCA in the frontward left side area of the host vehicle SV, and a right side collision area RCA in the frontward right side side of the host vehicle SV. The ECU 20 specifies an “object that is present in at least one of the left side collision area LCA and the right side collision area RCA, and that is coming close to the host vehicle SV” as a side approaching object. The ECU 20 determines whether or not the object is coming close to the host vehicle SV based on the relative speed Vr included in the radar object information.

When the side approaching object is present, the ECU 20 performs an alert control (an alert control) as the above-described predetermined control. In the alert control, the ECU 20 causes the display device 46 to display “an alert screen to notify the driver of the presence of the side approaching object”. The alert screen may include information to notify the driver of which side, the left side or the right side, the side approaching object is present at. When a side approaching object is present in the frontward left side arear and another side approaching object is present in the frontward right side area, the alert screen may notify the driver that the side approaching object is present at each of the left side and the right side,

It should be noted that, in the alert control, the EUC 20 causes the speaker 48 to generate a buzzer sound in place of displaying the alert screen. Furthermore, in the alert control, the EUC 20 may display the alert screen and generate the buzzer sound simultaneously.

The ECU 20 performs the above-described alert control and a deceleration control when the driver takes his/her foot off (releases) the brake pedal and depresses the acceleration pedal in a case where the side approaching object is present. In the deceleration control, the ECU 20 controls the power train actuator 42 and the brake actuator 44 in such a manner that a deceleration Gdec of the host vehicle SV becomes equal to a predetermined target deceleration Gtgt.

The alert control of the above-described control may sometimes be referred to as an FCTA (an abbreviation of a Front Cross Traffic Alert). The deceleration control of the above-described control may sometimes be referred to as an FCTB (an abbreviation of a Front Cross Traffic Brake).

It should be noted that the ECU 20 may perform at least one of the alert control and the deceleration control, as the above-described control.

### Outline of Operation

The present apparatus 10 determines whether or not a blocking condition is satisfied. The blocking condition is a condition to be satisfied when there is a “sensor object detected by the sensor” at a position where the sensor object blocks the full scan of the sensor. When the blocking condition is satisfied, the present apparatus 10 receives “external object information on an object that is present/located outside of the host vehicle SV and is detected by the external device” by communicating with the external device through the communication device 36. Examples of the external device may include a vehicle that is able to carry out a vehicle-to-vehicle communication with the host vehicle SV, and a predetermined infrastructure equipment (roadside equipment) that is able to communicate with the host vehicle SV. The infrastructure equipment comprises a sensor capable of detecting an object. The infrastructure equipment is able to transmit the external object information including a position of the object detected by the sensor with respect to the infrastructure equipment, a relative speed of that object with respect to the infrastructure equipment, and a position of the infrastructure equipment.

The present apparatus 10 determines whether or not the side approaching object is present based on (both of) the host-vehicle-object-information and the external object information, when the blocking condition is satisfied. Whereas, when the blocking condition is not satisfied, the present apparatus 10 determines whether or not the side approaching object is present based (solely) on the host-vehicle-object-information. The present apparatus 10 performs the above-described control when (it is determined that) the side approaching object is present.

### <Blocking Condition>

The present apparatus 10 determines that the blocking condition becomes satisfied, when all of “a host vehicle speed condition, a relative speed condition, and a position condition” described below are satisfied.

The host vehicle speed condition: a condition to be satisfied when the vehicle speed Vs is equal to or lower than a predetermined vehicle speed threshold Vsth.

The relative speed condition: a condition to be satisfied when a magnitude of the relative speed Vr of the object with respect to the host vehicle SV is equal to or lower than a predetermined speed threshold Vrth.

The position condition: a condition to be satisfied when a lateral distance Dy that is a distance in the vehicle width direction between the object and the host vehicle SV is equal to or shorter than a predetermined distance threshold Dyth.

As one example, the vehicle speed threshold Vsth has been set at a vehicle speed Vs (e.g., 5 km/h) of when the host vehicle SV creeps. As one example, the speed threshold Vrth has been set at 0 km/h. When the relative speed Vr of the object is 0 km/h, the object continues being at a position where the object blocks the full scan of the sensor. As one example, the distance threshold Dyth has been set at a distance Dy (e.g., 3.5 m) between the object and the host vehicle SV of when the object is located in an adjacent lane. This is because, if the object is located at a position that is farther than the adjacent lane, that object is unlikely to block the full scan of the sensor.

When the blocking condition is not satisfied, the present apparatus 10 does not use the external object information to determine whether to carry out the above-described control, since the present apparatus 10 can determine whether or not the side approaching object is present based solely on the host-vehicle-object-information. This can reduce a load for processing the external object information.

Whereas, when the blocking condition is satisfied, the present apparatus 10 uses the both of the external object information and the host-vehicle-object-information to determine whether to carry out the above-described control, since the present apparatus 10 cannot determine whether or not the side approaching object is present based solely on the host-vehicle-object-information. This enables the present apparatus 10 to accurately determine whether or not the side approaching object is present, and thus, to perform the above-described control appropriately.

### Example of Operation

An example of operation of the present apparatus 10 will next be described with reference to FIG. 3. In a scene shown in FIG. 3, an adjacent vehicle NV is present at the right side of the host vehicle SV. In addition, in the scene shown in FIG. 3, it is assumed that the blocking condition is satisfied. Namely, it is assumed that the vehicle speed Vs of the host vehicle SV is equal to or lower than the vehicle speed threshold Vsth, the magnitude of the relative speed Vr of the adjacent vehicle NV is equal to or lower than the speed threshold Vrth, and the lateral distance Dy of the adjacent vehicle NV is equal to or shorter than the distance threshold Dyth.

As shown in FIG. 3, the adjacent vehicle NV blocks the detection area DR2R of the rightward millimeter wave radar 26R. Therefore, the rightward millimeter wave radar 26R cannot fully scan the detection area DR2R. As shown in FIG. 3, although “an approaching vehicle IV that is coming close to (approaching) the host vehicle SV from the right side of the host vehicle SV” is present in the right side collision area RCA, the rightward millimeter wave radar 26R cannot detect the approaching vehicle IV, because the detection area DR2R is blocked by the adjacent vehicle NV.

Since the blocking condition is satisfied according to the above-described assumptions, the present apparatus 10 obtains the external object information from the external device. Examples of the external device may include the adjacent vehicle NV (i.e., the adjacent vehicle NV that the rightward millimeter wave radar 26R has been detecting). The adjacent vehicle NV also comprises a camera 22, a millimeter wave radar 24, a leftward millimeter wave radar 26L, and a rightward millimeter wave radar 26R, similarly to the host vehicle SV. The rightward millimeter wave radar 26R of the adjacent vehicle NV has been detecting the approaching vehicle IV in its detection area DR2R′. The adjacent vehicle NV transmits external object information on an object detected by the sensor (the camera 22, the millimeter wave radars 24, 26L, and 26R) mounted on the adjacent vehicle NV to the host vehicle SV. As one example, the external object information includes a position of the object with respect to the adjacent vehicle NV, the relative speed of the object with respect to the adjacent vehicle NV, and a current (present) position (expressed by the latitude and the longitude) of the adjacent vehicle NV.

When the blocking condition is satisfied, the present apparatus 10 obtains the external object information from the adjacent vehicle NV, and determines whether or not the object is the side approaching object based on the host-vehicle-object-information and the external object information. A process for the present apparatus 10 to determine whether or not the object is the side approaching object based on the external object information is described. Firstly, the present apparatus 10 specifies the position of the object with respect to the host vehicle SV, based on the position of the object with respect to the adjacent vehicle NV, the current position of the adjacent vehicle NV, and the current position of the host vehicle SV. In addition, the present apparatus 10 determines whether or not the object is coming close to the host vehicle SV, based on the relative speed of the object with respect to the adjacent vehicle NV, and the relative speed Vr of the adjacent vehicle NV with respect to the host vehicle SV.

This enables the present apparatus 10 to specify the position of the approaching vehicle IV with respect to the host vehicle SV, although the approaching vehicle IV has not been able to be detected by the rightward millimeter wave radar 26R because the detection area DR2R has been blocked. Since the approaching vehicle IV is the side approaching object that is located in the right side collision area RCA and is coming close to the host vehicle SV, the present apparatus 10 performs the above-described control.

### Specific Operation

### <Side Control Routine>

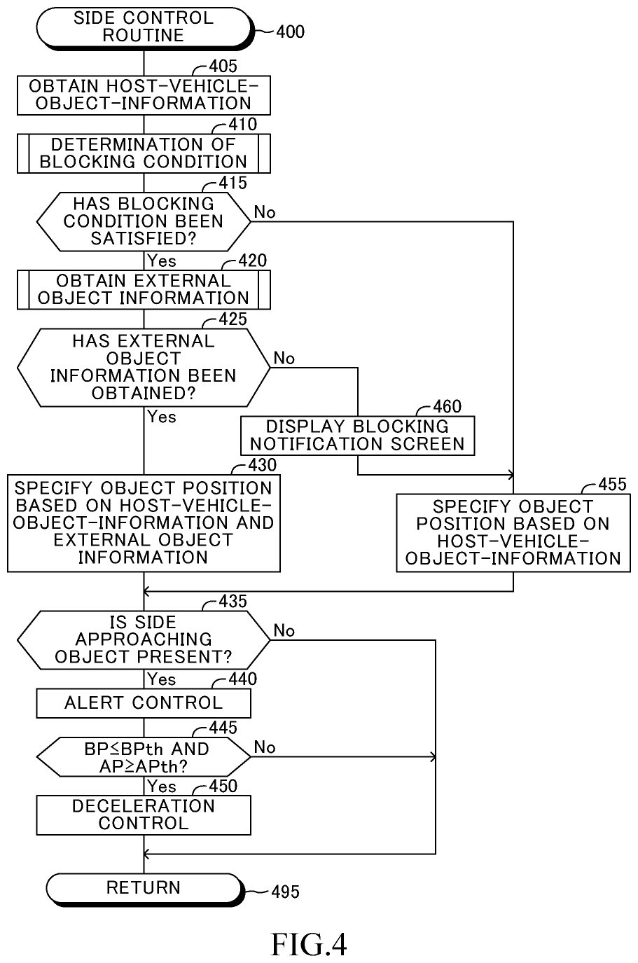

The CPU of the ECU 20 is configured or programmed to execute a routine shown by a flowchart in FIG. 4 every time a predetermined time elapses.

When an appropriate time point comes, the CPU starts processing from step 400 in FIG. 4, and sequentially executes the processes of step 405 to step 415.

Step 405: the CPU obtains the host-vehicle-object-information.

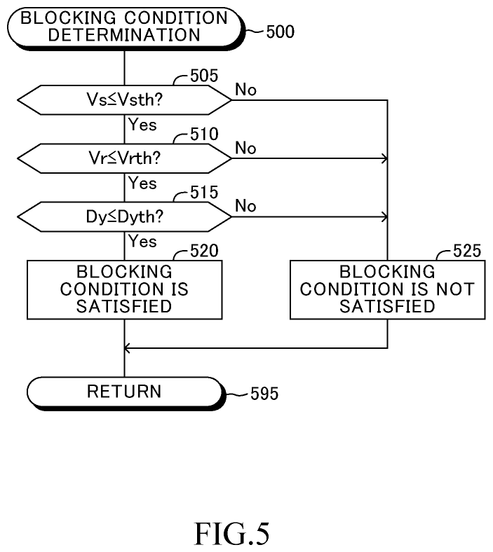

Step 410: the CPU executes a blocking condition determination sub routine to determine whether or not the blocking condition is satisfied. The blocking condition determination sub routine will be described later in detail with reference to FIG. 5.

Step 415: the CPU determines whether or not the blocking condition has been satisfied.

When the blocking condition has been satisfied, the CPU makes a “Yes” determination at step 415, and executes the processes of step 420 and step 425.

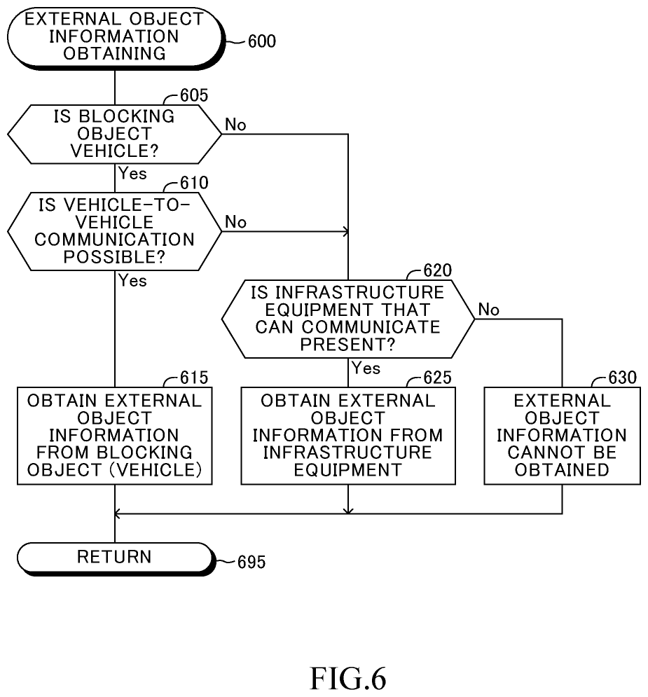

Step 420: the CPU executes an external object information obtaining sub routine for obtaining the external object information. The external object information obtaining sub routine will be described later in detail with reference FIG. 6.

Step 425: the CPU determines whether or not the external object information has been successfully obtained.

When the external object information has been successfully obtained, the CPU makes a “Yes” determination at step 425, and executes the processes of step 430 and step 435.

Step 430: the CPU specifies the position of the object with respect to the host vehicle SV based on the host-vehicle-object-information and the external object information.

Step 435: the CPU determines whether or not the side approaching object is present.

When the side approaching object is present, the CPU determines that a collision possibility that the host vehicle collides with the object is high (determines that the host vehicle is likely to collide with the object). In this case, the CPU makes a “Yes” determination at step 435, and executes the processes of step 440 and step 445.

Step 440: the CPU performs the above-described alert control.

Step 445: the CPU determines whether or not the brake operation amount BP is equal to or smaller than a predetermined operation amount threshold BPth, and the acceleration operation amount AP is equal to or greater than a predetermined operation amount threshold APth.

When the brake operation amount BP is equal to or smaller than the operation amount threshold BPth, and the acceleration operation amount AP is equal to or greater than the operation amount threshold APth, the CPU determines that the driver has taken his/her foot off the brake peal and has depressed the acceleration pedal. In this case, the CPU makes a “Yes” determination at step 445, and proceeds to step 450. At step 450, the CPU performs the above-described deceleration control. Thereafter, the CPU proceeds to step 495 to terminate the present routine tentatively.

If the blocking condition is not satisfied when the CPU proceeds to step 415, the CPU makes a “No” determination at step 415, and proceeds to step 455. At step 455, the CPU specifies the position of the object with respect to the host vehicle SV based on the host-vehicle-object-information. Thereafter, the CPU executes the processes of the step 435 and of steps following the step 435.

If the external object information has not been successfully obtained when the CPU proceeds to step 425, the CPU makes a “No” determination at step 425, and proceeds to step 460. At step 460, the CPU causes the display device 46 to display a blocking notification screen. The blocking notification screen is a screen for notifying the driver that the blocking condition becomes satisfied, and causing the driver to pay attention to a blocked direction. Thereafter, the CPU executes the processes of the step 455 and of steps following the step 455.

If the side approaching object is not present when the CPU proceeds to step 435, the CPU determines that the collision possibility is low (determines that the host a collision is not likely to happen). In this case, the CPU makes a “No” determination at step 435, and proceeds to step 495 to terminate the present routine tentatively.

When the CPU proceeds to step 445, and if the brake operation amount BP is greater than the operation amount threshold BPth or the acceleration operation amount AP is smaller than the operation amount threshold APth, the CPU makes a “No” determination at step 445, and proceeds to step 495 to terminate the present routine tentatively.

### <Blocking Condition Determination Sub Routine>

When the CPU proceeds to step 410 shown in FIG. 4, the CPU starts processing from step 500 in FIG. 5, and proceeds to step 505. At step 505, the CPU determines whether or not the host vehicle speed condition is satisfied (namely, determines whether or not the vehicle speed Vs is equal to lower than the vehicle speed threshold Vsth).

When the host vehicle speed condition is satisfied (namely, when the vehicle speed Vs is equal to lower than the vehicle speed threshold Vsth), the CPU makes a

“Yes” determination at step 505, and proceeds to step 510. At step 510, the CPU determines whether or not there is an object that satisfies the relative speed condition (namely, an object whose magnitude of the relative speed Vr is equal to or lower than the speed threshold Vrth is present) among objects whose positions are determined to be in the side direction of the host vehicle SV based on the host-vehicle-object-information.

When the object that satisfies the relative speed condition is present, the CPU makes a “Yes” determination at step 510, and proceeds to step 515. At step 515, the CPU determines whether or not the “object that satisfies the relative speed condition” satisfies the position condition (namely, whether or not the lateral distance Dy of that object is equal to or shorter than the distance threshold Dyth).

When that object satisfies the position condition (namely, when the lateral distance Dy of that object is equal to or shorter than the distance threshold Dyth), the CPU makes a “Yes” determination at step 515, and proceeds to step 520. At step 520, the CPU determines that the blocking condition is satisfied. Thereafter, the CPU proceeds to step 595 to terminate the present routine tentatively, and proceeds to step 415 shown in FIG. 4.

If the host vehicle speed condition is not satisfied when the CPU proceeds to step 505, the CPU makes a “No” determination at step 505, and proceeds to step 525. At step 525, the CPU determines that the blocking condition is not satisfied. Thereafter, the CPU proceeds to step 595 to terminate the present routine tentatively, and proceeds to step 415 shown in FIG. 4.

If the object that satisfies the relative speed condition is not present when the CPU proceeds to step 510, the CPU makes a “No” determination at step 510, and proceeds to step 525. If the object that satisfies the relative speed condition does not satisfy the position condition when the CPU proceeds to step 515, the CPU makes a “No” determination at step 515, and proceeds to step 525.

### <External Object Information Obtaining Sub Routine>

When the CPU proceeds to step 420 shown in FIG. 4, the CPU starts processing from step 600 in FIG. 6, and proceeds to step 605. At step 605, the CPU determines whether or not a kind of the object that satisfies the blocking condition (i.e., the blocking object) is a vehicle, based on the image data and a “reflection intensity of the reflected wave received by the millimeter wave radar”.

When the kind of the blocking object is a vehicle, the CPU makes a “Yes” determination at step 605, and proceeds to step 610. At step 610, the CPU determines whether or not the vehicle-to-vehicle communication with the blocking object is possible (can be carried out). More specifically, the CPU causes the communication device 36 to carry out the vehicle-to-vehicle communication with surrounding vehicles that are present around (in the vicinity of) the host vehicle SV so as to cause the communication device 36 to receive communication data from the surrounding vehicles. The communication data includes a position (expressed by the longitude and the latitude) of each of the surrounding vehicles. The CPU specifies the position (the longitude and the latitude) of the blocking object, based on the current position specified by the GNSS receiver 38 and the position of the blocking object with respect to the host vehicle SV. The CPU determines that the vehicle-to-vehicle communication with the blocking object is possible, when the position of the surrounding vehicles included in the communication data is within a predetermined area whose center is at the position of the blocking object.

When the vehicle-to-vehicle communication with the blocking object is possible, the CPU makes a “Yes” determination at step 610, and proceeds to step 615. At step 615, the CPU obtains the external object information from the blocking object by carrying out the vehicle-to-vehicle communication with the blocking object. Thereafter, the CPU proceeds to step 695 to terminate the present routine tentatively, and proceeds to step 425 shown in FIG. 4.

If the kind of the blocking object is not the vehicle when the CPU proceeds to step 605, the CPU makes a “No” determination at step 605, and proceeds to step 620. At step 620, the CPU determines whether or not there is an infrastructure equipment (roadside equipment) that can communicate with the host vehicle SV. The infrastructure equipment is equipped with a sensor capable of detecting an object, and is configured to be able to transmit external object information including a position of the object detected by the sensor.

When the above-described infrastructure equipment is present, the CPU makes a “Yes” determination at step 620, and proceeds to step 625. At step 625, the CPU obtains the external object information from the above-described infrastructure equipment. Thereafter, the CPU proceeds to step 695 to terminate the present routine tentatively, and proceeds to step 425 shown in FIG. 4.

When the above-described infrastructure equipment is not present, the CPU makes a “No” determination at step 620, and proceeds to step 630. At step 630, the CPU determines that the external object information cannot be obtained. Thereafter, the CPU proceeds to step 695 to terminate the present routine tentatively, and proceeds to step 425 shown in FIG. 4.

If the vehicle-to-vehicle communication with the blocking object is not possible when the CPU proceed to step 610, the CPU makes a “No” determination at step 610, and executes the processes of the step 620 and of steps following the step 620.

As has been described, the present apparatus 10 performs the above-described control based on the host-vehicle-object-information and the external object information when the blocking condition is satisfied, and performs the above-described control based on the host-vehicle-object-information when the blocking condition is not satisfied. Therefore, the present apparatus 10 can decrease the load for processing the external object information, and can perform the above-described control appropriately.

Furthermore, the present apparatus 10 determines that the blocking condition is satisfied when all of the host vehicle speed condition, the relative speed condition, and the position condition are satisfied. This enables the blocking condition to be accurately satisfied, when the object blocks the detection area of the sensor.

In addition, when the kind of the blocking object is the vehicle and the vehicle-to-vehicle communication with the blocking object is possible, the present apparatus 10 obtains the external object information from the blocking object. It is likely that the sensor mounted on the blocking object can fully scan the detection area of the sensor of the host vehicle blocked by the blocking object. Therefore, the present apparatus 10 can increase a possibility that the present apparatus 10 can obtain information on the object that is located in the detection area blocked by the blocking object.

The present disclosure should not be limited to the above-described embodiment, and may employ various modifications within the scope of the present disclosure.

### First Modification

The external object information does not have to include the relative speed of the object with respect to the external device (the vehicle or the infrastructure equipment). In this case, the CPU may obtain the relative speed of the object with respect to the external device, based on a history of the position of the object with respect to the external device.

### Second Modification

In the above embodiment, the CPU determines that the blocking condition is satisfied, when the host vehicle speed condition, the relative speed condition, and the position condition are satisfied. However, the CPU may determine that the blocking condition is satisfied, when the host vehicle speed condition, the relative speed condition, and a blocking area condition described below are satisfied.

The blocking area condition: a condition to be satisfied, when the object is present in a blocking area SA that has been determined in advance and that is in the side area of the host vehicle SV.

More specifically, as shown in FIG. 3, an “area at the right side of the host vehicle SV” that is likely to block the detection area DR2R of the rightward millimeter wave radar 26R has been set as a right blocking area RSA in advance. More specifically, as shown in FIG. 3, if an object is present in an area RSA at the right side of the host vehicle SV, the object is likely to block the detection area DR2R of the rightward millimeter wave radar 26R. Thus, the area RSA has been set as a right blocking area RSA in advance.

Similarly, an “area at the left side of the host vehicle SV” that is likely to block the detection area DR2L of the leftward millimeter wave radar 26L has been set as a left blocking area LSA in advance. Similarly, if an object is present in an area LSA at the left side of the host vehicle SV, the object is likely to block the detection area DR2L of the leftward millimeter wave radar 26L. Thus, the area LSA has been set as a left blocking area LSA in advance.

When the right blocking area RSA and the left blocking area LSA need not be differentiated from each other, each of them is referred to as a “blocking area SA”.

As one example, the blocking area SA has a rectangular shape. A length of the blocking area SA in the vehicle width direction of the host vehicle SV is about 3.5 m, and a length of the blocking area SA in the front-rear axis direction of the host vehicle SV is about 5.0 m.

### Third Modification

The CPU may determine that the blocking condition is satisfied when at least one of the position condition and the blocking area condition is satisfied. Alternatively, the CPU may determine that the blocking condition is satisfied, when at least one of the position condition and the blocking area condition is satisfied and when both of the host vehicle speed condition and the relative speed condition are satisfied.

The position condition, the blocking area condition, the host vehicle speed condition, and the relative speed condition may sometimes be referred to as a “fist condition”, a “second condition”, a “third condition”, and a “fourth condition”, respectively.

### Fourth Modification

In the above embodiment, the CPU displays the blocking notification screen, when the blocking condition is satisfied (step 415 shown in FIG. 4: Yes) and the external object information has not been obtained (step 425 shown in FIG. 4: No). Alternatively, the CPU may display the blocking notification screen, when the blocking condition is satisfied regardless of whether or not the external object information has been obtained.

### Fifth Modification

In the above embodiment, the CPU performs the above-described control when an execution condition is satisfied, since there is a higher possibility of the collision between the host vehicle SV and the object when the execution condition is satisfied than when the execution condition is not satisfied, wherein the execution condition is a condition to be satisfied when the object (side approaching object) that is coming close to the host vehicle SV is present in at least one the right side collision area RCA and the left side collision area LCA. However, the execution condition is not limited to the above condition.

For example, the CPU may perform the above-described control when a time (hereinafter, referred to as a “TTC”) required for the side approaching object to collide with the host vehicle SV is equal to or shorter than a predetermined first time threshold T1th. TTC is an abbreviation of Time To Collision. The CPU obtains the TTC by dividing the distance D between the side approaching object and the host vehicle SV by the relative speed Vr of the side approaching object with respect to the host vehicle SV.

In addition, the CPU may perform the above-described control when the above-described distance D is equal to or shorter than a distance threshold Dth.

Each of the TTC and the distance D is an indicative value indicative of a collision possibility, and may sometimes be expressed as a collision indicative value. The collision possibility of when the TTC is equal to or shorter than the first time threshold T1th is higher than the collision possibility of when the TTC is longer than the first time threshold T1th. The collision possibility of when the distance D is equal to or shorter than the distance threshold Dth is higher than the collision possibility of when the distance D is longer than the distance threshold Dth.

### Sixth Modification

In the above embodiment, the CPU performs the control (the FCTA and the FCTB) for the object that is coming close to the host vehicle SV from the side area of the host vehicle SV. The CPU in the present modification may perform a control (at least one of the alert control and the deceleration control) for an object that is coming close to the host vehicle SV from a position in front of the host vehicle SV. An example of this kind of the control is a PCS (Pre-Crash Safety). Each of the predetermined control described in the above-described embodiment and the predetermined control described in the present modification may be expressed as a control for avoiding the collision between the host vehicle SV and the object or for mitigating the damage caused by the collision.

The CPU specifies an object (frontward object) that is present in front of the host vehicle SV based on the camera object information and the radar object information from the frontward millimeter wave radar 24. The CPU obtains the TTC of the frontward object, and performs the above-described control when the TTC is equal to or shorter than a second time threshold T2th.

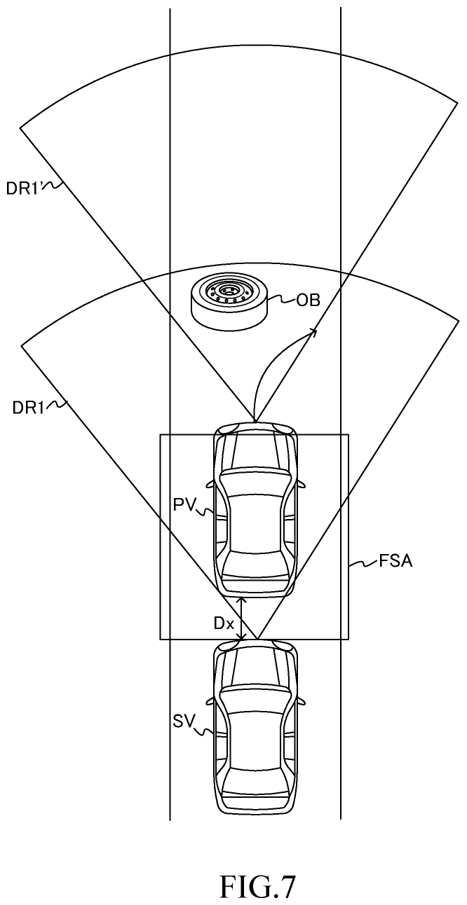

As shown in FIG. 7, the CPU cannot detect an obstacle OB that is present in front of a “preceding vehicle PV traveling in front of the host vehicle SV” when the preceding vehicle PV blocks a shooting area of the camera 22 and the detection area DR1 of the frontward millimeter wave radar 24. Therefore, when the preceding vehicle PV changes a moving direction in order to avoid the obstacle OB, a timing at which the above-described control for the host vehicle SV is performed may be delayed.

In view of the above, when a blocking condition described below is satisfied, the CPU of the present modification obtains external object information, and recognizes an object that is present in front of the host vehicle SV based on the host-vehicle-object-information and the external object information. Thereafter, the CPU obtains the TTC of the recognized object that is present in front of the host vehicle SV, and performs the above-described control when the TTC is equal to or shorter than the second time threshold T2th.

### <Blocking Condition>

The blocking condition of the present modification is satisfied, when both of the above described relative speed condition and a front position condition described below are satisfied.

The front position condition: a condition to be satisfied when a longitudinal distance Dx between the object (detected based on the host-vehicle-object-information) and the host vehicle SV in the front-rear axis direction of the host vehicle SV is equal to or shorter than a predetermined distance threshold Dxth.

It should be noted that, when the kind of the blocking object is a vehicle and the vehicle-to-vehicle communication with that vehicle is possible (namely, when the preceding vehicle PV causes the blocking condition to be satisfied and the vehicle-to-vehicle communication between the preceding vehicle and the host vehicle SV is possible), the CPU obtains the external object information through the vehicle-to-vehicle communication with that vehicle.

With this configuration, in the example shown in FIG. 7, since the CPU of the host vehicle SV obtains the external object information from the preceding vehicle PV, the CPU can recognize an obstacle OB before the preceding vehicle changes the traveling direction. Therefore, the CPU can perform the above-described control at an appropriate timing.

In the present modification, the CPU may determine that the blocking condition is satisfied, when both of the above-described relative speed condition and a frontward blocking area condition described below are satisfied.

The frontward blocking area condition: a condition to be satisfied when an object is present in a frontward blocking area FSA that has been set in front of the host vehicle SV.

As shown in FIG. 7, an “area in front of the host vehicle SV” that is likely to block the detection area DR1 of the frontward millimeter wave radar 24 has been set as the frontward blocking area FSA in advance. More specifically, as shown in FIG. 7, if an object is present in an area FSA in front of the host vehicle SV, the object is likely to block the detection area DR1 of the frontward millimeter wave radar 24. Thus, the area FSA has been set as the frontward blocking area FSA in advance.

It should be noted that the CPU determines that the blocking condition is satisfied, when at least one of the front position condition and the frontward blocking area condition is satisfied. Alternatively, the CPU may determine that the blocking condition is satisfied, when at least one of the front position condition and the frontward blocking area condition is satisfied and when the relative speed condition is satisfied.

The present apparatus 10 may be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). The present apparatus 10 can also be applied to an autonomous control vehicle. In addition, the present disclosure may include a non-volatile storage device/medium into which a program for realizing the functions of the present apparatus 10 is stored and from which the program is read out by the computer.

What is claimed is:

1. A vehicle control apparatus comprising:
a sensor, mounted on a host vehicle, configured to detect an object that is present outside of said host vehicle, and obtain host-vehicle-object-information on said detected object;
a receiving device configured to receive external object information on an object detected by an external device that is located outside of said host vehicle from said external device; and
a control unit capable of performing a predetermined control based on at least said host-vehicle-object-information;
wherein,
said control unit is configured to:
perform said control based on said host-vehicle-object-information when a blocking condition is not satisfied, said blocking condition being a condition to be satisfied when a sensor object that is an object detected by said sensor is present at a position where said sensor object blocks a full scan of said sensor; and
perform said control based on said host-vehicle-object-information and said external object information when said blocking condition is satisfied.

2. The vehicle control apparatus according to claim 1,
wherein,
said control unit is configured to determine that said blocking condition is satisfied, when at least one of a first condition and a second condition is satisfied,
said first condition being a condition to be satisfied when a distance between said host vehicle and said sensor object is equal to or shorter than a predetermined distance; and
said second condition being a condition to be satisfied when said sensor object is located in a blocking area that has been set outside of said host vehicle.

3. The vehicle control apparatus according to claim 2,
wherein,
said control unit is configured to determine that said blocking condition is satisfied, when at least one of said first condition and said second condition is satisfied and when both of a third condition and a fourth condition are satisfied;
said third condition being a condition to be satisfied when a vehicle speed of said host vehicle is equal to or lower than a first speed threshold; and
said fourth condition being a condition to be satisfied when a magnitude of a relative speed of said sensor object with respect to said host vehicle is equal to or lower than a second speed threshold.

4. The vehicle control apparatus according to one of claims 1,
wherein,
said control unit is configured to:
when said blocking condition is not satisfied, perform said control based on a collision possibility of a collision between said host vehicle and an object recognized based on said host-vehicle-object-information; and
when said blocking condition is satisfied, perform said control based on a collision possibility of a collision between said host vehicle and an object recognized based on said host-vehicle-object-information and said external object information.

5. The vehicle control apparatus according to claim 4,
wherein,
said sensor is configured to detect an object that is present in a side area of said host vehicle as said sensor object, and to obtain said host-vehicle-object-information on said sensor object; and
said control unit is configured to:
in a case where said blocking condition is not satisfied, perform, as said control, at least one of an alert control to notify a driver of presence of said object and a deceleration control to decelerate said host vehicle, when it is determined that said object recognized based on said host-vehicle-object-information is present in a predetermined side collision area that has been set in a side area of said host vehicle and is coming close to said host vehicle; and
in a case where said blocking condition is satisfied, perform, as said control, at least one of said alert control and said deceleration control, when it is determined that said object recognized based on said host-vehicle-object-information and said external object information is present in said side collision area and is coming close to said host vehicle.

6. The vehicle control apparatus according to claim 1, wherein,
said control unit is configured to, when a kind of said sensor object that is present at said position where said sensor object blocks said full scan of said sensor is a vehicle, obtain said external object information by carrying out a vehicle-to-vehicle communication with this vehicle.

7. The vehicle control apparatus according to claim 1,
wherein,
when said blocking condition is satisfied, said control unit is configured to notify a driver that said blocking condition is satisfied.

8. A vehicle control method executed by a computer installed on a host vehicle to perform a predetermined control based on host-vehicle-object-information on a sensor object that is an object outside of said host vehicle which a sensor mounted on said host vehicle detects, comprising:
a first step of performing said control based on said host-vehicle-object-information when a blocking condition is not satisfied, said blocking condition being a condition to be satisfied when said sensor object is present at a position where said sensor object blocks a full scan of said sensor; and
a second step of obtaining external object information on an object detected by an external device outside of said host vehicle from said external device, and of performing said control based on said host-vehicle-object-information and said external object information, when said blocking condition is satisfied.

9. A program storage device, readable by machine, storing a program for causing a computer installed on a host vehicle to perform a predetermined control based on host-vehicle-object-information on a sensor object which a sensor mounted on said host vehicle detects, said program causing said computer to implement processes of:
performing said control based on said host-vehicle-object-information when a blocking condition is not satisfied, said blocking condition being a condition to be satisfied when said sensor object is present at a position where said sensor object blocks a full scan of said sensor; and
obtaining external object information on an object detected by an external device outside of said host vehicle from said external device, and performing said control based on said host-vehicle-object-information and said external object information, when said blocking condition is satisfied.
